(19) United States
(12) Patent Application Publication
(10) Pub. No.: US 2017/0261529 A1
(43) Pub. Date: Sep. 14, 2017

(54) METHOD FOR IDENTIFYING FRICTION PARAMETER FOR LINEAR MODULE

(71) Applicant: HIWIN TECHNOLOGIES CORP., Taichung City (TW)

(72) Inventors: Meng-Shiun TSAI, Chia-Yi County (TW); Wei-Hsiang YUAN, New Taipei City (TW); Chih-Wei WANG, Taichung City (TW); Hong-Wei HUANG, Chia-Yi County (TW); Chung-Ching LIU, Chia-Yi County (TW)

(21) Appl. No.: 15/608,732

(22) Filed: May 30, 2017

Related U.S. Application Data
(63) Continuation-in-part of application No. 14/478,940, filed on Sep. 5, 2014.

(30) Foreign Application Priority Data
Jun. 26, 2014 (TW) 103122131

(51) Int. Cl. G01P 3/06; G05B 17/02; G01L 5/24

(52) U.S. Cl. CPC G01P 3/06; G01L 5/24; G05B 17/02

(57) ABSTRACT

A method for identifying friction parameters for a linear module is disclosed. Since an acting interval of a friction is determined by a relative velocity between two contacting surfaces, and when the relative velocity is much greater than a Stribeck velocity, there is only a Coulomb friction and a viscous friction exist between the contacting surfaces, it is possible to use a measured torque signal of this interval to identify a Coulomb friction torque, a the linear module's friction torque, and the linear module's equivalent inertia. When the relative velocity between the two contacting surfaces is smaller than the Stribeck velocity, it is possible to identify a maximum static friction torque and the Stribeck velocity by referring to the three known parameters. Thereby, all the friction parameters can be identified within one reciprocating movement of the linear module, making the method highly feasible in practice.

### BACKGROUND OF THE INVENTION

Technical Field

The present invention relates to linear systems, and more particularly to a method for identifying friction parameters for linear module.

2. Description of Related Art

For automated equipment using ball screws, the automated equipment's accuracy of positioning mainly relies on the ball screw's preload that eliminates backlash in the ball screw and increase the rigidity of the ball screw. However, such preload inevitably increases friction between the contacting surfaces, and leads to quadrant errors when the screw shaft changes directions at a high speed, thereby affecting adversely the accuracy of the automated equipment.

For addressing this issue, a known approach involves using a LuGre friction model to build up a relation curve between the friction torque and the velocity, and then identifying the relevant parameters by means of curve fitting. However, the use of the LuGre friction model requires many times of fixed velocity friction tests, making this known approach greatly limited and thus less feasible in practice. In addition, in the process of performing curve fitting, since there are too many parameters remain unknown, the identification is quite difficult.

### BRIEF SUMMARY OF THE INVENTION

The primary objective of the present invention is to provide a method for identifying friction parameters for a linear module, which eliminates the use of multiple fixed velocity friction tests, so as to make the parameter-identifying process much easier and much more feasible in practice.

For achieving the foregoing objective, in the disclosed method for identifying friction parameters for linear module, friction parameters T_{c} is the Coulomb friction torque; σ₂ is the viscous friction coefficient; Tₛ is the maximum static friction torque; ωₛ is the Stribeck velocity; the method is used in a drive module and a linear module. The drive module comprises a controller, a driver, a motor having an output shaft), and a sensor. The controller has the functions of storing, computing and outputting data, and can receive a position command or a speed command and convert the received position command or said speed command into a driving signal. The position command driver is electrically connected to the controller for receiving the driving signal from the controller and then driving the connected motor to rotate the output shaft according to the received driving signal. The sensor is electrically connected to the motor. After detected the torque or the revolving velocity of the output shaft of the motor, the sensor transmits the detected torque or the revolving velocity data to the controller. The method comprises the steps of:
step a) S1, Input a position command into the controller for causing the controller to drive the motor through the driver according to the inputted position command, so that the output shaft can drive the drive member to move the driven member back and forth for one cycle; driven member
step b) S2, During movement of the driven member, driven member the sensor outputs the detected motor torque and the revolving velocity to the controller;
step c) S3, The controller uses an arithmetic logic pre-stored in the controller to calculate the motor torque and the revolving velocity data, identifying T_{c}, that is the Coulomb friction torque; σ₂ that is the viscous friction coefficient; Tₛ that is the maximum static friction torque; ωₛ that is the Stribeck velocity.

Thereby, the disclosed method divides the linear module moving into a high-speed segment interval and a low-speed segment interval, so that all the relevant parameters can be identified during the linear module's one reciprocating movement, so as to make the parameter-identifying process much easier and much more feasible in practice.

### BRIEF DESCRIPTION OF THE SEVERAL VIEWS OF THE DRAWINGS

FIG. 1 is a schematic drawing illustrating the system architecture of the present invention.

FIG. 2 is a flowchart of a method for identifying a friction parameter for linear module according to the present invention.

FIG. 3 graphically illustrates sinusoidal position planning performed in the present invention.

FIG. 4 graphically illustrates trapezoidal position planning performed in the present invention.

### DETAILED DESCRIPTION OF THE INVENTION

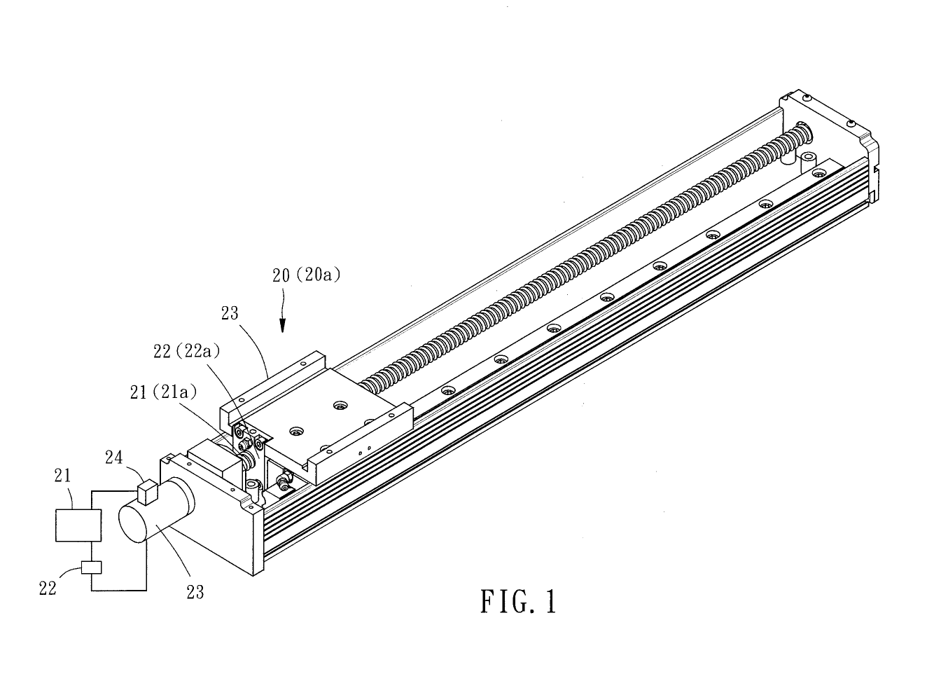

Referring to FIG. 1, according to the present invention, a method for identifying friction parameters for a linear module comprises a step a) S1, a step b) S2, and a step c) S3. In LuGre friction model, the friction parameters to be identified are T_{c} that is the Coulomb friction torque, σ₂ that is the viscous friction coefficient, Tₛ that is the maximum static friction torque, and ωₛ that is Stribeck velocity.

It is to be noted that, in the present preferred embodiment, the identification method is used in a linear module 10. The linear module 10 is driven by a drive module 20. The drive module 20 comprises a controller 21, a driver 22, a motor 23 with an output shaft (not shown), and a sensor 24. The controller 21 has the function of storing, computing and outputting data, and can receive a position command or a speed command and convert the received position command or said speed command into a driving signal. The driver 22 is electrically connected to the controller 21, and adapted for receiving the driving signal from the controller 21 and driving the connected motor 23 subject to the received driving signal to control the rotation of the output shaft. The sensor 24 is electrically connected to the motor. When detected the torque or the revolving velocity of the output shaft of the motor 23, the sensor 24 outputs the torque data and the revolving velocity data of the motor 23 to the controller 21.

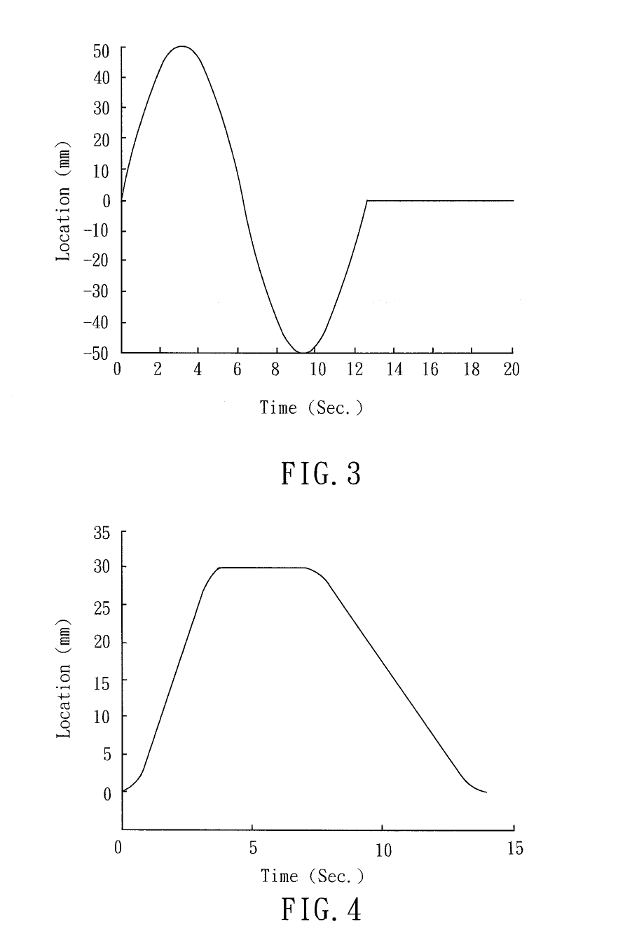

The linear module 20 is a combination structure in which the inertia does not change with the position. The linear module 20 comprises a drive member 21 and a driven member 22. The drive member 21 is electrically connected to the output shaft of the motor 23. The driven member 22 is mounted at the drive member 21, and can be rotated or horizontally moved relative to the driven member 22. Further, the position command here controls the position of the driven member 22 at every time point, FIGS. 3 and 4 illustrate the time-position relationship.

In the present preferred embodiment, the linear module 20 is a linear platform 20a. The linear platform 20a comprises a screw rod 21a and a platform 23. The platform 23 is pivotally connected with a screw nut 22a. The screw nut 22a is threaded onto the screw rod 21a, and drivable to carry the platform 23 horizontally upon rotation of the screw rod 21a. The screw rod 21a is regarded as the drive member 21 of the linear module. The combination of the screw nut 22a and the platform 23 is regarded as the driven member 22.

However, in case of robotic arm, it is not applicable to the present preferred embodiment, because the attitude of the robotic arm will change during movement, this makes the overall inertia of the robotic arm to change with the change of the position.

In the step a) S1, input a position command into the controller 21, causing the controller 21 to drive the driver 22 in rotating the motor 23 subject to the position command so that the output shaft can drive the drive member 21 to move the driven member 22 Back and forth through one cycle.

In the step b) S2, causing said sensor 24 to output the detected said torque data and/or said the revolving velocity data to said controller 21 during movement of said driven member 22.

In the step c) S3, the controller 21 uses an arithmetic logic therein to calculate the torque data and the revolving velocity data of the motor 23, thereby identifying T_{c}, that is the Coulomb friction torque, σ₂ that is the viscous friction coefficient, Tₛ that is a maximum static friction torque, and ωₛ that is the Stribeck velocity.

The arithmetic logic is explained hereinafter. A first equation is derived from a LuGre friction model. The first equation is written as

T_{f}=T_{c}sgn(ω)+(Tₛ−T_{c})e^{-(ω/ω}^{ₛ}⁾^{²}sgn(ω)+σ₂ω (1)

With respect to equation (1), please refer to Karl Johan Astrom, Carlos Canudas de Wit. Revisiting the LuGre friction model. IEEE Control Systems Magazine, Institute of Electrical and Electronics Engineers, 2008, 28 (6), pp.101-114.

T_{f} is the linear module's friction torque, which represents the torque needed to overcome the friction during the operation of the output shaft of the motor to move the linear module.

T_{c} is the Coulomb friction torque, which represents the torque needed to overcome the Coulomb friction between the screw rod and the screw nut block.

ω is the revolving velocity of the output shaft of the motor, which represents the revolving velocity of the motor measured by the sensor and which is not an identification parameter.

Tₛ is the maximum static friction torque, which represents the torque needed to overcome the maximum static friction.

ωₛ is the Stribeck velocity. The Stribeck velocity ωₛ is 1.5.

σ₂ is a viscous friction coefficient.

Then, a second equation is used to identify the friction parameters. This second equation is a common physical equation. The second equation is

Tₘ=Jα+T_{f}, (2)

With respect to equation (2), please refer to Karl Johan Astrom, Carlos Canudas de Wit. Revisiting the LuGre friction model. IEEE Control Systems Magazine, Institute of Electrical and Electronics Engineers, 2008, 28 (6), pp. 101-114.

where Tₘ is the motor's output torque, which represents the output torque of the motor that is measured by the sensor and that is not an identification parameter.

J is the linear module' equivalent inertia

α is an angular acceleration of the output shaft of the motor, which is derived from a differential on the motor revolving velocity detected by the sensor and which is not an identification parameter.

Then by combining the first and second equations, a parametric equation is obtained. The parametric equation is

Tₘ=Jα+T_{c}sgn(ω)+(Tₛ−T_{c})e^{-(ω/ω}^{ₛ}⁾^{²}sgn(ω)+σ₂ω. (3)

when, ω is much greater than ωₛ the linear module is in the high-speed segment. At this time, (Tₛ−T_{c})e^{-(ω/ω}^{ₛ}⁾^{²} sgn(ω) is close to 0, so the parametric equation (3) can be simplified into Tₘ=Jα+T_{c}sgn(ω)+σ₂ω. Therein, Tₘ and ω are directly measured.

After ω is identified, α can be in turn identified by performing ω in differentiation once. At this time, there are two ways to identify J, T_{c} and σ₂.

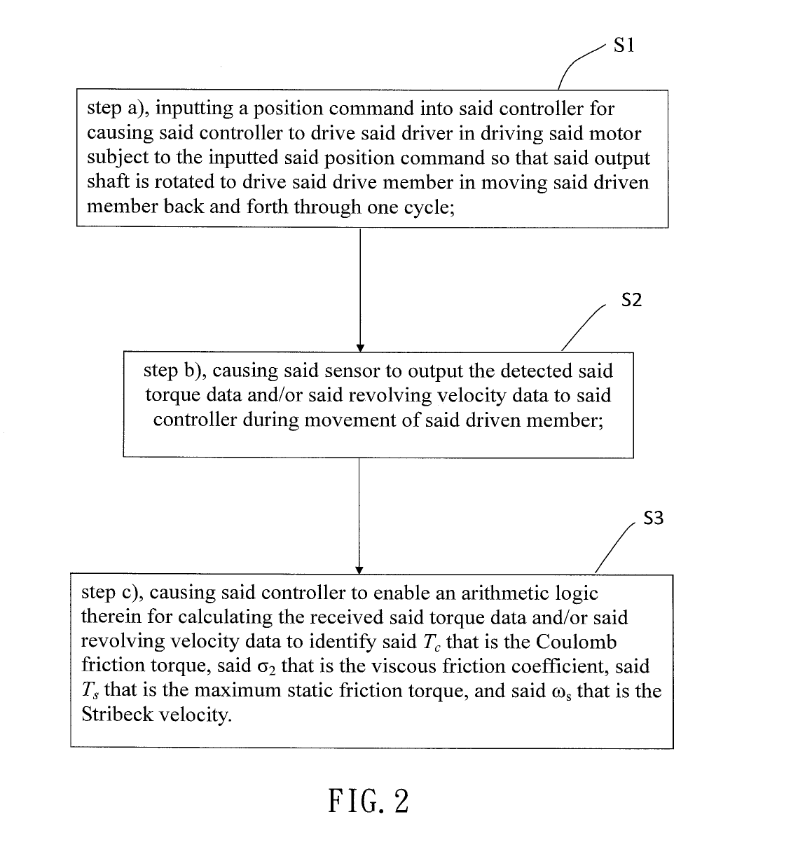

In a first approach, sinusoidal position planning (as shown in FIG. 2) is used to arrange the plural measuring signals in the high-speed segment into the following matrix: after N times detection by the sensor, the torque data and the revolving velocity data of the output shaft are written into a matrix form:

$$[ \begin{matrix}{T}_{m}^{1} \\ {T}_{m}^{2} \\ ⋮ \\ {T}_{m}^{N}\end{matrix} ] = [ \begin{matrix}{α}_{1} & 1 & {ω}_{1} \\ {α}_{2} & 1 & {ω}_{2} \\ ⋮ & ⋮ & ⋮ \\ {α}_{N} & 1 & {ω}_{N}\end{matrix} ] [ \begin{matrix}J \\ {T}_{c} \\ {σ}_{2}\end{matrix} ] ,$$

and making Y=AX, where Y is a vector composed of the motor's output torques Tₘ, A is a matrix composed of the motor output shaft's angular acceleration a and the motor output shaft's angular speed ω, and X is a vector composed of the parameters to be identified. At this time, the previous matrix can be rewritten into:

$$[ \begin{matrix}J \\ {T}_{c} \\ {σ}_{2}\end{matrix} ] = {( \begin{matrix}{A}^{T} & A\end{matrix} )}^{- 1} {A}^{T} Y ,$$

and by using the least square method, J, T_{c} and σ₂ can be obtained.

The second approach is to use trapezoidal position planning (as shown in FIG. 3) to define ωₚ, ωₙ, Tₚ, and Tₙ , Assuming that the forward process is positive, the backward process is negative where ωₚ is the linear module's angular speed during departure within the fixed-velocity segment, |ωₚ|>>ωₛ, ωₙ is the linear module's angular speed during return within the fixed-velocity segment, |ωₙ|>>ωₛ, Tₚ is the motor's output torque during the linear module's departure within the fixed-velocity segment, and Tₙ the motor's output torque during the linear module's return within the fixed-velocity segment. Since the motor output shaft's angular acceleration a in the fixed-velocity segment is 0 the parametric equation of the step a) can be rewritten into

$$\{ \begin{matrix}{T}_{p} = {T}_{c} + {σ}_{2} {ω}_{p} \\ {T}_{n} = - {T}_{c} + {σ}_{2} {ω}_{n}\end{matrix} ,$$

so as to derive

$${σ}_{2} = \frac{{T}_{p} + {T}_{n}}{{ω}_{p} + {ω}_{n}} , {T}_{c} = {T}_{p} - \frac{{T}_{p} + {T}_{n}}{{ω}_{p} + {ω}_{n}} {ω}_{p} .$$

After σ₂ and T_{c} are derived,

$$J = \frac{{T}_{m} - {T}_{c} sgn ( ω ) - {σ}_{2} ω}{α}$$

can be obtained by using the measuring signals in the high-speed segment (ω is much greater than ωₛ) and the parametric equation (3).

when ω is smaller than ωₛ or close to ωₛ, the linear module is located in the low-speed segment interval.

At this time, (Tₛ−T_{c})e^{-(ω/ω}^{ₛ}⁾^{²} sgn(ω) is not closed to 0.

Since J, T_{c} and σ₂ have been identified, there are only Tₛ and ωₛ remaining in the parametric equation as unknown parameters. At this time, two ways may be considered, as stated below.

As a third approach, the unknown parameters and the parameters identified in the first or second approach are separated and their natural logarithms are taken, respectively, so as to make the parametric equation (3) become a linear equation that is written as

ln(Tₘ−Jα−T_{c}sgn(ω)−σ₂ω)=ln(Tₛ−T_{c})−(ω/ωₛ)²sgn(ω)

p=q−ω²r, where p=ln(Tₘ−Jα−T_{c}sgn(ω)−σ₂ω), and q=ln(Tₛ−T_{c}), r=1/(ωₛ)². Since p can be determined by substituting the known parameters, and ω can be found through direct measurement, q and r can be easily obtained, and in turn Tₛ and ωₛ can be identified.

As a forth approach, the parametric equation is first rewritten into: Tₘ−Jα=(Tₛ−T_{c})e^{-(ω/ω}^{ₛ}⁾^{²} sgn(ω)+T_{c}sgn(ω)+σ₂ω, and then Tₛ and ωₛ are identified by means of curve fitting. At this time, there are only two parameters remaining unknown, so the process of curve fitting can be significantly simplified.

To sum up, the disclosed method divides the linear module's moving velocity into a high-speed segment interval and a low-speed segment interval, so that by making the linear module perform only one reciprocating movement, all the relevant parameters can be identified. As compared to the prior art, the present invention makes identification of the parameters much more easier and much more feasible in practice.

What is claimed is:

1. A method used in a linear module for identifying friction parameters for said linear module, in which the friction parameters T_{c} is the Coulomb friction torque; σ₂, is the viscous friction coefficient; Tₛ, is the maximum static friction torque; ωₛ is the Stribeck velocity, said linear module being driven by a drive module, said drive module comprising a controller, a driver, a motor with an output shaft and a sensor, said controller having a function of storing, computing and outputting a data and being capable of receiving a position command or a speed command and converting the received said position command or said speed command into a driving signal, said driver being electrically connected to said controller and adapted for receiving said driving signal from said controller and then driving the connected said motor to rotate said output shaft according to said driving signal, said sensor being electrically connected to said motor and adapted for detecting the torque and/or the revolving velocity of said output shaft of said motor and then transmitting the detected said torque and/or said revolving velocity to said controller, the method comprising the steps of:
step a), inputting a position command into said controller for causing said controller to drive said driver in driving said motor subject to the inputted said position command so that said output shaft is rotated to drive said drive member in moving said driven member back and forth through one cycle;
step b), causing said sensor to output the detected said torque data and/or said revolving velocity data to said controller during movement of said driven member; and
step c), causing said controller to enable an arithmetic logic therein for calculating the received said torque data and/or said revolving velocity data to identify said T_{c} that is the Coulomb friction torque, said σ₂ that is the viscous friction coefficient, said Tₛ that is the maximum static friction torque, and said ωₛ that is the Stribeck velocity.
